(19) United States
(12) Patent Application Publication
(10) Pub. No.: US 2014/0068178 A1
(43) Pub. Date: Mar. 6, 2014

(54) WRITE PERFORMANCE OPTIMIZED FORMAT FOR A HYBRID DRIVE

(71) Applicants: Daniel Scott Fisher, Dublin, CA (US); Daniel Raymond Zaharris, Longmont, CO (US)

(72) Inventors: Daniel Scott Fisher, Dublin, CA (US); Daniel Raymond Zaharris, Longmont, CO (US)

(73) Assignee: LSI Corporation

(21) Appl. No.: 13/596,733

(22) Filed: Aug. 28, 2012

(51) Int. Cl. G06F 12/08

(52) U.S. Cl. 711/113; 711/E12.017

(57) ABSTRACT

An apparatus for optimizing write performance of a hybrid drive includes a magnetic medium that stores data with respect to the hybrid drive and a plurality of write cache regions configured on the magnetic medium. When a write request is received by the hybrid drive, a head of the hybrid drive is automatically positioned to a nearest write cache region for writing of data to at least one write cache region without rotational orientation, thereby eliminating rotational latency and optimizing the write performance of the hybrid drive. The hybrid drive also updates normal data regions of the magnetic medium with data comprising write cached data during drive idle time, freeing up the write cache regions for future writes.

### TECHNICAL FIELD

Embodiments are generally related to hybrid disk drives. Embodiments are also related to techniques for optimizing the performance of hybrid disk drives. Embodiments also relate to magnetic storage media for use with hybrid disk drives.

### BACKGROUND OF THE INVENTION

A typical hybrid drive includes a hard disk drive (HDD) with solid-state NVM employed as a cache memory. The attraction of a hybrid drive (also referred to a hybrid HDD or hybrid disk drive) is that data or programs that are frequently accessed from the HDD are stored in non-volatile memory acting as a cache for the HDD. As a result, in theory, a hybrid drive is supposed to increase performance, reduce access time, and reduce power. Hybrid drives, however, have not lived up to their promise for a number of reasons, some of which are explained in greater detail below.

Referring now to FIG. 1, a functional block diagram of an example hard disk drive (HDD) 100 is depicted. The HDD 100 shown in FIG. 1 generally includes a hard disk assembly (HDA) 101 and a HDD printed circuit board (PCB) 102. The HDA 101 may include a magnetic medium 103, such as one or more platters (e.g., a disk) that store data, and a read/write device 104. The read/write device 104 may be arranged on an actuator arm 105 and may read and write data on the magnetic medium 103.

Additionally, the HDA 101 includes a spindle motor 106 that rotates the magnetic medium 103 and a voice-coil motor (VCM) 107 that actuates the actuator arm 105. A preamplifier device 108 amplifies signals generated by the read/write device 104 during read operations and provides signals to the read/write device 104 during write operations.

The HDD PCB 102 includes a read/write channel module (hereinafter, “read channel”) 109, a hard disk controller (HDC) module 110, volatile memory 111, nonvolatile memory 112, a processor 113, and a spindle/VCM driver module 114. The read channel 109 processes data received from and transmitted to the preamplifier device 108.

The HDC module 110 controls components of the HDA 101 and communicates with a host device (not shown) via an I/O interface 115. The host device may include a computer, a multimedia device, a mobile computing device, etc. The I/O interlace 115 may include wireline and/or wireless communication links.

The HDC module 110 may receive data from the HDA 101, the read channel 109, volatile memory 111, nonvolatile memory 112, the processor 113, the spindle/VCM driver module 114, and/or the I/O interface 115. The processor 113 may process the data, including encoding, decoding, filtering, and/or formatting.

The processed data may be output to the HDA 101, the read channel 109, volatile memory 111, nonvolatile memory 112, the processor 113, the spindle/VCM driver module 114, and/or the I/O interface 115. The spindle/VCM driver module 114 controls the spindle motor 106 and the VCM 107. The HDD PCB 102 includes a power supply 116 that provides power to the components of the HDD 100. The HDC module 110 may use volatile memory 111 and/or nonvolatile memory 112 to store data related to the control and operation of the HDD 100.

Volatile memory 111 may include dynamic random access memory (DRAM), synchronous DRAM, Rambus DRAM, etc. Nonvolatile memory 112 may include flash memory (including NAND and NOR flash memory), static RAM, magnetic RAM, phase change memory, and multi-state memory, in which each memory cell has more than two states.

Referring now to FIG. 2, a functional block diagram of a hybrid HDD 150 is depicted. A HDD PCB 152 of the hybrid HDD 150 includes nonvolatile cache 154, which communicates with the HDC module 110. The nonvolatile cache 154 may include any suitable type of nonvolatile memory such as flash memory. The nonvolatile cache 154 may store data waiting to be written to the HDA 101, data waiting to be read by the I/O interface 115, and/or temporary values.

The HDA 101 can be powered down, and data waiting to be written to the HDA 101 can be cached in the nonvolatile cache 154. Once the nonvolatile cache 154 fills with data waiting to be written, and/or upon the occurrence of other conditions, the HDA 101 is powered up and the cached data is written to the HDA 101.

Powering down the HDA 101 saves power and makes the hybrid HDD 150 less prone to failure as a result of impact and vibration. The nonvolatile cache 154 can also cache frequently accessed data. When this data is requested by the I/O interface 115, the data can be provided quickly from the nonvolatile cache 154 without delays due to seeking and rotational latencies of the HDA 101.

The nonvolatile cache 154 can also store data that allows the host device associated with the hybrid HDD 150 to quickly resume from a powered down state. When the host device is powered down or placed in hibernate mode, resume data required to quickly power up the host device can be stored in the nonvolatile cache 154. The resume data may include certain data stored in the HDA 101, the addresses of which are referred to as a pinned set. When hibernating, the resume data may include some or all of the contents of volatile memory of the host device.

In order to support these features, the nonvolatile cache 154 typically contains a large amount of nonvolatile semiconductor storage. For example only, the nonvolatile cache 154 may include gigabytes of storage. Nonvolatile semiconductor storage is typically expensive and typically also has a finite lifetime.

Typically, in the prior art, a hybrid drive operates much as a conventional cache memory does. Initially, when a block of data is retrieved or read from the HDD, it may be also cached in the NVM as determined by a caching algorithm. If a subsequent read request is to the same block, then the data from the NVM is read. However, if the subsequent read request is to a non-cached block, then the data from the different block is read from the HDD media. A read-caching algorithm in the HDC determines what data is cached in NVM and may replace old data for new data when the NVM is full. The host may also provide information to the hybrid HDD regarding what blocks to save in NVM for read caching.

In some hybrid drives, a portion of the memory of the NVM is dedicated to store operating system programs or the like which are always used and can never be replaced no matter how infrequently they are used.

Hybrid drives are thus implemented using a combination of conventional rotating magnetic recording technology (HDD) and flash non-volatile memory in order to implement a higher performance high capacity storage system. A Hybrid drive system provides increased performance by caching “hot” data (referred to as blocks) in the flash NVM (non-volatile memory) so that subsequent access to this data are immediate and not subject to the typical mechanical latencies in a HDD due to head seek and rotational positioning times. The amount of flash NVM in a hybrid is small in order to minimize the additional cost.

The flash NVM in a hybrid drive system could also be used as a write cache to reduce the mechanical latency time of a HDD in much the same way as reads, but there are limitations. Writing to flash NVM is typically much slower than reading (>an order of magnitude) due to the nature of flash devices. The amount of flash NVM is small and this creates some issues. First, a portion of the flash NVM could be allocated to a write cache, but this reduces the memory available for read caching; and second, flash NVM has a finite number of program/erase cycles and after that number is reached the device is no longer reliable.

Hence, it can be appreciated that there is a continuing need to improve the performance of hybrid drives.

Note that the background description provided herein is for the purpose of generally presenting the context of the disclosure. Such information as described in this background section, as well as aspects of the description that may not otherwise qualify as prior art at the time of filing, are neither expressly nor impliedly admitted as prior art against the present disclosure.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved hybrid drive.

It is another aspect of the disclosed embodiments to provide for a write performance optimized format for a hybrid drive.

It is a further aspect of the disclosed embodiments to provide for an improved magnetic storage media having write cache regions for improving write performance in a hybrid drive.

The aforementioned aspects and other objectives and advantages can now be achieved as described herein. An apparatus for optimizing write performance of a hybrid drive is disclosed. Such an apparatus generally includes a magnetic medium that stores data with respect to the hybrid drive and a plurality of write cache regions configured on the magnetic medium. When a write request is received by the hybrid drive, a head of the hybrid drive is automatically positioned to a nearest write cache region for writing of data to at least one write cache region without rotational orientation, thereby eliminating rotational latency and optimizing the write performance of the hybrid drive. The hybrid drive also updates normal data regions of the magnetic medium with data comprising write cached data during drive idle time, freeing up the write cache regions for future writes.

In some embodiments, the magnetic medium comprises a magnetic storage medium such as a magnetic storage disk. The magnetic medium thus includes both normal data regions and write cache regions. Additionally, the write cache regions comprise equally spaced write cache regions and normally formatted data is locatable between the spaced write cache regions.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a functional block diagram of a hard disk drive (HDD) according to the prior art;

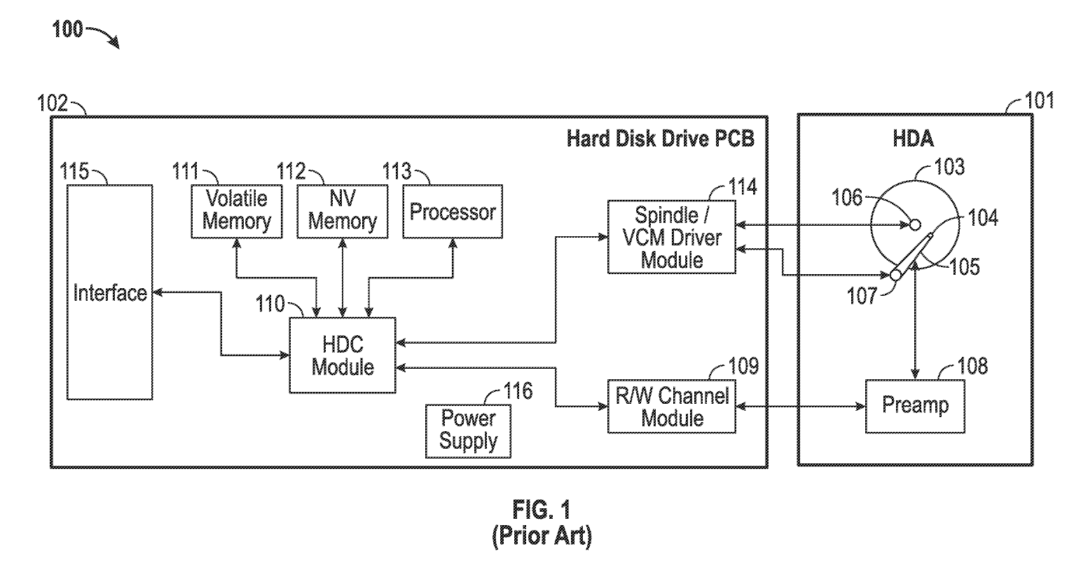

FIG. 2 illustrates a functional block diagram of a hybrid HDD according to the prior art; and

FIG. 3 illustrates a magnetic storage medium with write cache regions thereof, in accordance with the disclosed embodiments.

### DETAILED DESCRIPTION

The particular values and configurations discussed in these non-limiting examples can be varied and are cited merely to illustrate at least one embodiment and are not intended to limit the scope thereof. The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

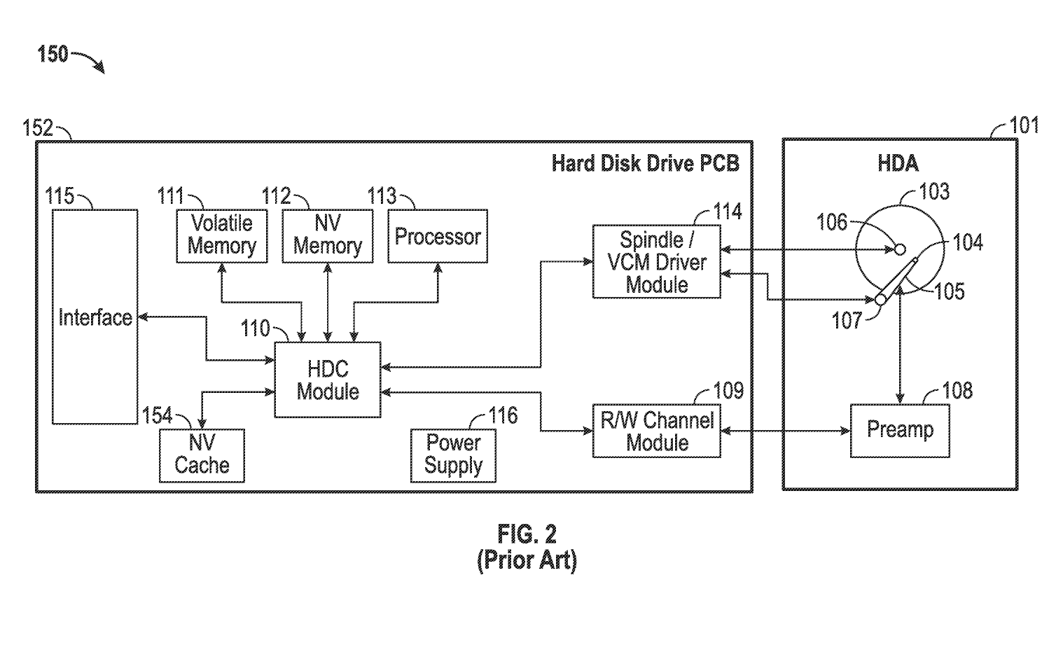

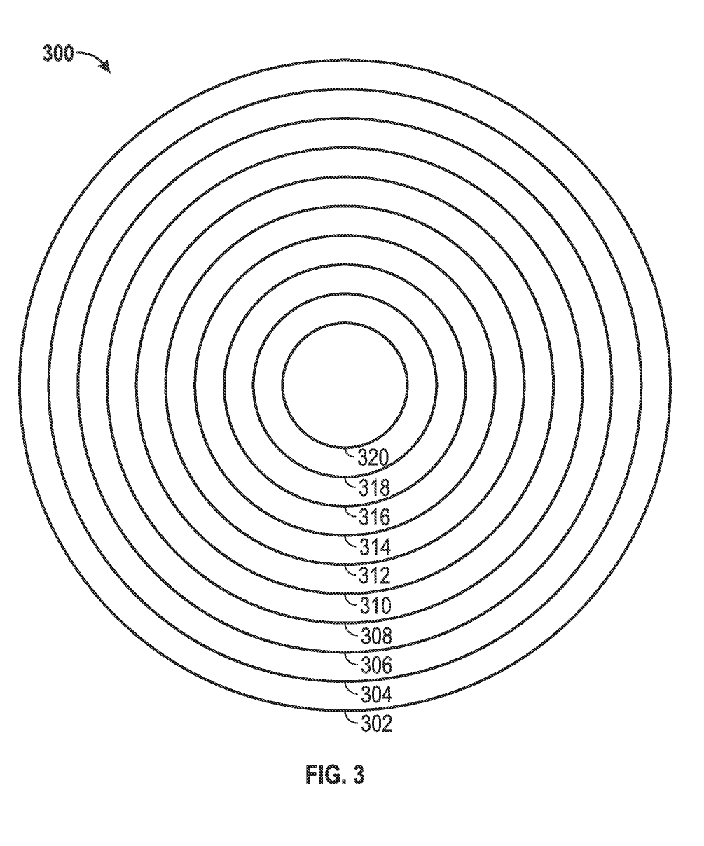

FIG. 3 illustrates a graphic view of a magnetic medium 300 having a number of write cache regions 302-320, in accordance with the disclosed embodiments. The write performance in a hybrid drive such as, for example, the hybrid HDD 150 shown in FIG. 2, can be increased by creating write cache regions 302-320 on the magnetic medium 300 (e.g., disk), but at the expense of some capacity. In the case of the hybrid drive 150 shown in FIG. 2, the magnetic medium 300 may be utilized in place of the magnetic medium 103. In the example shown in FIG. 3, the disk or magnetic medium 300 is shown with the write cache regions 302-320 (denoted by the black lines).

When a write request is received by the hybrid HDD 150, for example, the hybrid HDD head is positioned to the nearest write region, minimizing seek latency. These write cache regions 302-320 can be written to without rotational orientation, thereby eliminating rotational latency. The more regions that are available, the less head seek latency is experienced at the expense of some capacity overhead. The hybrid drive 150, for example, can then update the normal data regions of the disk or magnetic medium 300 with the write cached data during drive idle time, freeing up the region for future writes. A hybrid drive with ˜16 write cache regions, for example, could obtain a ˜12× improvement in write IOP performance improvement with very little overhead. The number and size of write cache regions can be modeled and optimized for a given Hybrid HDD.

Based on the foregoing, it can be appreciated that a number of embodiments, preferred and alternative, are disclosed. In one embodiment, an apparatus is disclosed for optimizing write performance of a hybrid drive. Such an apparatus can include a magnetic medium that stores data with respect to the hybrid drive and a plurality of write cache regions configured on the magnetic medium such that when a write request is received by the hybrid drive, a head of the hybrid drive is automatically positioned to a nearest write cache region among the plurality of write cache regions for writing of data to at least one write cache region among the plurality of write cache regions without rotational orientation, thereby eliminating rotational latency and optimizing the write performance of the hybrid drive.

In another embodiment, the hybrid drive updates normal data regions of the magnetic medium with data comprising write cached data during drive idle time, freeing up the plurality of write cache regions for future writes. In yet another embodiment, the magnetic medium can constitute a disk. In still other embodiments, the magnetic medium can include the normal data regions and the plurality of write cache regions. In yet other embodiments, the plurality of write cache regions can include equally spaced write cache regions among the plurality of write cache regions.

In another embodiment, normally formatted data is locatable between each of the equally spaced write cache regions among the plurality of write cache regions. In still other embodiments, a number and a size of the plurality of write cache regions on the magnetic medium are capable of being modeled and optimized for a particular hybrid drive.

In another embodiment, a method can be implemented for optimizing write performance of a hybrid drive. Such a method can include, for example, the steps of providing a magnetic medium that stores data with respect to the hybrid drive; and configuring a plurality of write cache regions on the magnetic medium such that when a write request is received by the hybrid drive, a head of the hybrid drive is automatically positioned to a nearest write cache region among the plurality of write cache regions for writing of data to at least one write cache region among the plurality of write cache regions without rotational orientation, thereby eliminating rotational latency and optimizing the write performance of the hybrid drive.

In another embodiment, a step or operation can be implemented for configuring the hybrid drive to update normal data regions of the magnetic medium with data comprising write cached data during drive idle time, freeing up the plurality of write cache regions for future writes. In still another embodiment, a step or operation can be implemented for configuring the plurality of write cache regions to comprise equally spaced write cache regions among the plurality of write cache regions, wherein normally formatted data is locatable between each of the equally spaced write cache regions among the plurality of write cache regions.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. An apparatus for optimizing write performance of a hybrid drive, said apparatus comprising:
a magnetic medium that stores data with respect to said hybrid drive; and
a plurality of write cache regions configured on said magnetic medium such that when a write request is received by said hybrid drive, a head of said hybrid drive is automatically positioned to a nearest write cache region among said plurality of write cache regions for writing of data to at least one write cache region among said plurality of write cache regions without rotational orientation, thereby eliminating rotational latency and optimizing said write performance of said hybrid drive.

2. The apparatus of claim 1 wherein said hybrid drive updates normal data regions of said magnetic medium with data comprising write cached data during drive idle time, freeing up said plurality of write cache regions for future writes.

3. The apparatus of claim 1 wherein said magnetic medium comprises a disk.

4. The apparatus of claim 2 wherein said magnetic medium comprises said normal data regions and said plurality of write cache regions.

5. The apparatus of claim 1 wherein said plurality of write cache regions comprises equally spaced write cache regions among said plurality of write cache regions.

6. The apparatus of claim 5 wherein normally formatted data is locatable between each of said equally spaced write cache regions among said plurality of write cache regions.

7. The apparatus of claim 1 wherein a number and a size of said plurality of write cache regions on said magnetic medium are capable of being modeled and optimized for a particular hybrid drive.

8. The apparatus of claim 1 wherein said hybrid drive updates normal data regions of said magnetic medium with data comprising write cached data during drive idle time, freeing up said plurality of write cache regions for future writes and wherein said magnetic medium comprises said normal data regions and said plurality of write cache regions.

9. The apparatus of claim 8 wherein a number and a size of said plurality of write cache regions on said magnetic medium are capable of being modeled and optimized for a particular hybrid drive.

10. The apparatus of claim 8 wherein said plurality of write cache regions comprises equally spaced write cache regions among said plurality of write cache regions and wherein normally formatted data is locatable between each of said equally spaced write cache regions among said plurality of write cache regions.

11. The apparatus of claim 8 wherein said magnetic medium comprises a disk.

12. An apparatus for optimizing write performance of a hybrid drive, said apparatus comprising:
a magnetic medium that stores data with respect to said hybrid drive; and
a plurality of write cache regions configured on said magnetic medium such that when a write request is received by said hybrid drive, a head of said hybrid drive is automatically positioned to a nearest write cache region among said plurality of write cache regions for writing of data to at least one write cache region among said plurality of write cache regions without rotational orientation, thereby eliminating rotational latency and optimizing said write performance of said hybrid drive, and wherein said hybrid drive updates normal data regions of said magnetic medium with data comprising write cached data during drive idle time, freeing up said plurality of write cache regions for future writes.

13. The apparatus of claim 12 wherein said magnetic medium comprises a disk.

14. The apparatus of claim 13 wherein said magnetic medium comprises said normal data regions and said plurality of write cache regions.

15. The apparatus of claim 12 wherein said plurality of write cache regions comprises equally spaced write cache regions among said plurality of write cache regions.

16. The apparatus of claim 15 wherein normally formatted data is locatable between each of said equally spaced write cache regions among said plurality of write cache regions.

17. The apparatus of claim 12 wherein a number and a size of said plurality of write cache regions on said magnetic medium are capable of being modeled and optimized for a particular hybrid drive.

18. A method for optimizing write performance of a hybrid drive, said method comprising:
providing a magnetic medium that stores data with respect to said hybrid drive; and
configuring a plurality of write cache regions on said magnetic medium such that when a write request is received by said hybrid drive, a head of said hybrid drive is automatically positioned to a nearest write cache region among said plurality of write cache regions for writing of data to at least one write cache region among said plurality of write cache regions without rotational orientation, thereby eliminating rotational latency and optimizing said write performance of said hybrid drive.

19. The method of claim 18 further comprising configuring said hybrid drive to update normal data regions of said magnetic medium with data comprising write cached data during drive idle time, freeing up said plurality of write cache regions for future writes.

20. The method of claim 18 further comprising configuring said plurality of write cache regions to comprise equally spaced write cache regions among said plurality of write cache regions, wherein normally formatted data is locatable between each of said equally spaced write cache regions among said plurality of write cache regions.
